(19) United States
(12) Patent Application Publication
(10) Pub. No.: US 2014/0278582 A1
(43) Pub. Date: Sep. 18, 2014

(54) SYSTEMS AND METHODS FOR FACILITATING REQUESTS AND QUOTATIONS FOR INSURANCE

(71) Applicant: OFERTA, INC., SAN DIEGO, CA (US)

(72) Inventors: Michael R. Shambach, San Diego, CA (US); Jamie Reid, San Diego, CA (US)

(73) Assignee: OFERTA, INC., SAN DIEGO, CA (US)

(21) Appl. No.: 14/211,737

(22) Filed: Mar. 14, 2014

Related U.S. Application Data
(60) Provisional application No. 61/793,852, filed on Mar. 15, 2013.

(51) Int. Cl. G06Q 40/08

(52) U.S. Cl. CPC G06Q 40/08
USPC 705/4

(57) ABSTRACT

Systems and methods for presenting multiple insurance quotations. In an embodiment, a request for insurance, comprising class code(s), is received from a business-user. The request for insurance is communicated to agent-users, and quotations are received from the agent-users. Each quotation comprises, for each class code, a rating basis and a net rate. A user interface for analyzing the quotations is provided to the business-user. Specifically, the user interface comprises information for the quotations in a grid comprising cells arranged in both a vertical and a horizontal direction, with each quotation represented in a first direction, and each class code represented in a second direction. For each quotation and for each class code, cell(s), corresponding to the quotation and the class code comprise the rating basis, net rate, and an insurance premium amount for the class code.

### CROSS-REFERENCE TO RELATED APPLICATIONS

This application claims priority to U.S. Provisional Patent App. No. 61/793,852, filed on Mar. 15, 2013 and titled “Systems and Methods for Facilitating Requests and Quotations for Insurance,” the entirety of which is hereby incorporated herein by reference.

This application is related to U.S. patent application Ser. No. 13/019,957, filed on Feb. 2, 2011, titled “Systems and Methods for Purchasing Insurance,” and published as U.S. Patent Pub. No. 2012/0197667 on Aug. 2, 2012, and U.S. patent application Ser. No. 13/019,960, filed on Feb. 2, 2011, titled “Systems and Methods for Purchasing Insurance,” and published as U.S. Patent Pub. No. 2012/0197668 on Aug. 2, 2012 (collectively, “the Related Applications”), the entireties of both of which are hereby incorporated herein by reference.

### BACKGROUND

1. Field of the Invention

The embodiments described herein are generally directed to facilitating insurance requests and quotations, and, more particularly, to a web-based system that provides user interfaces and tools that enable businesses to submit insurance requests, receive insurance quotations from multiple insurance agents, analyze and compare insurance quotations, communicate with insurance agents, accept insurance quotations, and/or the like, and enable agents to receive insurance requests, submit insurance quotations, communicate with businesses receiving insurance quotations, and/or the like.

2. Description of the Related Art

The ease of accessing and reviewing insurance information online (e.g., over the Internet) and the speed of electronic processing has attracted consumers to insurance providers having an online presence. At first, many insurance providers set up Internet websites that enabled consumers to locate agents of the insurance providers. For example, a consumer would submit address information to an insurance provider's website and receive a list of agents of that insurance provider that were qualified for the type of insurance that the consumer was seeking and that were in geographical proximity to the consumer.

In the next step of evolution, insurance providers began providing insurance quotations via their online websites. For example, an insurance provider would, through its website, provide a brief questionnaire regarding the insurability of a consumer's property or business and the desired insurance, and then calculate an estimated cost of insurance based on the consumer's answers to the questionnaire. The estimated cost would then be presented to the consumer with an invitation to the consumer to contact the insurance provider or one of its agents, offline, in order to pursue the insurance coverage.

In a third step of evolution, as transmission security improved on the Internet and consumers became increasingly willing to provide information necessary for insurance coverage via the Internet, insurance providers began providing insurance application processes online. For example, a consumer was provided with user interfaces that enabled the consumer to submit information required for processing an insurance application. However, deficiencies remained to prevent the completion of an entire insurance application process. For example, insurance providers generally required confirmation of a consumer's identity, and consumers often required confirmation of an agent's identity prior to the completion of a transaction.

In a fourth step of evolution, systems and methods were disclosed in the Related Applications that addressed the deficiencies which prevented a complete online insurance application and purchase process. However, efficient user interfaces and tools are needed to further streamline and advance the online insurance application and purchase process.

### SUMMARY

Accordingly, systems and methods are disclosed for facilitating the online insurance application, quotation, and purchase process.

In an embodiment, a system for presenting multiple insurance quotations for a request for insurance is disclosed. The system comprises: at least one hardware processor; and one or more software modules that, when executed by the at least one hardware processor, receives a request for insurance from a business-user, the request for insurance comprising one or more class codes; communicates the request for insurance to a plurality of agent-users; receives a plurality of quotations for the request for insurance from the plurality of agent users, wherein each of the plurality of quotations comprise, for each of the one or more class codes, a rating basis and a net rate; and provides a user interface to the business-user, wherein the user interface comprises information for two or more of the plurality of quotations in a grid comprising cells arranged in both a vertical direction and a horizontal direction, wherein each of the two or more quotations is represented in a first one of the vertical direction and the horizontal direction, wherein each of the one or more class codes is represented in a second one of the vertical direction and the horizontal direction, and wherein, for each of the two or more quotations, for each of the one or more class codes, one or more cells, corresponding to the quotation in the first direction and the class code in the second direction, comprise the rating basis, the net rate, and an insurance premium amount for the class code.

In an additional embodiment, a non-transitory computer-readable medium having one or more sequences of instructions stored therein is disclosed. The one or more sequences of instructions, when executed by a processor, cause the processor to: receive a request for insurance from a business-user, the request for insurance comprising one or more class codes; communicate the request for insurance to a plurality of agent-users; receive a plurality of quotations for the request for insurance from the plurality of agent users, wherein each of the plurality of quotations comprise, for each of the one or more class codes, a rating basis and a net rate; and provide a user interface to the business-user, wherein the user interface comprises information for two or more of the plurality of quotations in a grid comprising cells arranged in both a vertical direction and a horizontal direction, wherein each of the two or more quotations is represented in a first one of the vertical direction and the horizontal direction, wherein each of the one or more class codes is represented in a second one of the vertical direction and the horizontal direction, and wherein, for each of the two or more quotations, for each of the one or more class codes, one or more cells, corresponding to the quotation in the first direction and the class code in the second direction, comprise the rating basis, the net rate, and an insurance premium amount for the class code.

In an additional embodiment, a method for presenting multiple insurance quotations for a request for insurance is disclosed. The method comprises using at least one hardware processor to: receive a request for insurance from a business-user, the request for insurance comprising one or more class codes; communicate the request for insurance to a plurality of agent-users; receive a plurality of quotations for the request for insurance from the plurality of agent users, wherein each of the plurality of quotations comprise, for each of the one or more class codes, a rating basis and a net rate; and provide a user interface to the business-user, wherein the user interface comprises information for two or more of the plurality of quotations in a grid comprising cells arranged in both a vertical direction and a horizontal direction, wherein each of the two or more quotations is represented in a first one of the vertical direction and the horizontal direction, wherein each of the one or more class codes is represented in a second one of the vertical direction and the horizontal direction, and wherein, for each of the two or more quotations, for each of the one or more class codes, one or more cells, corresponding to the quotation in the first direction and the class code in the second direction, comprise the rating basis, the net rate, and an insurance premium amount for the class code.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a network infrastructure around a platform for providing the user interfaces and online insurance processes disclosed herein, according to an embodiment, according to an embodiment;

FIGS. 2A-2E illustrate example user interfaces related to agent registration with the platform, according to an embodiment;

FIG. 2F illustrates an example user interface for an agent dashboard, according to an embodiment;

FIG. 3 illustrates an example user interface for an agent dashboard, according to an embodiment;

FIGS. 4A-4C illustrate example lead-specific user interfaces, according to an embodiment;

FIGS. 5A-5C illustrate example user interfaces related to business registration, according to an embodiment;

FIG. 5D illustrates an example authentication user interface, according to an embodiment;

FIG. 5E illustrates an example user interface for a business dashboard, according to an embodiment;

FIG. 6 illustrates an example user interface for a business dashboard, according to an embodiment;

FIGS. 7A-7C illustrate example user interfaces for initiating a request for insurance, according to an embodiment;

FIGS. 8A-8H illustrate example user interfaces for generating a request for insurance, according to an embodiment;

FIGS. 10A-10C illustrate example user interfaces for accepting an insurance quotation using a business dashboard, according to an embodiment;

FIGS. 11A-11C illustrate example user interfaces for a quote analyzer, according to an embodiment;

FIGS. 12A-12C illustrate example user interfaces for managing a loss history, according to an embodiment;

FIG. 13 illustrates a process for Market selection, according to an embodiment; and

FIG. 14 illustrates a processing system on which one or more of the processes described herein may be executed, according to an embodiment.

### DETAILED DESCRIPTION

In an embodiment, systems and methods are disclosed for facilitating the online insurance application and purchase process. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

FIG. 1 illustrates an example system for facilitating requests and/or quotations for insurance, according to an embodiment. The system may comprise a set of one or more servers 110 (also referred to herein as a “platform”) which host and/or execute one or more of the various functions, processes, methods, and/or software modules described herein. In addition, server(s) 110 may be communicatively connected to one or more user systems 130 via one or more network(s) 120 and may also be communicatively connected to one or more database(s) 112 (e.g., via one or more network(s), such as network(s) 120) and/or may comprise one or more database(s) 112. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and/or the like, as well as proprietary protocols. In an embodiment, server(s) 110 may not be dedicated servers, and may instead be cloud instances, which utilize shared resources of one or more servers. It should also be understood that server(s) 110 may be, but are not required to be, collocated. Furthermore, while server(s) 110 are illustrated as being connected to various systems through a single set of network(s) 120, it should be understood that server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, Automated Teller Machines, and/or the like. In addition, while only a few user systems 130, one set of server(s) 110, and one set of database(s) 112 are illustrated, it should be understood that the network may comprise any number of user systems, sets of server(s), and database(s).

Platform 110 may comprise web servers which host one or more websites or web services. In embodiments in which a website is provided, the website may comprise one or more user interfaces, including, for example, webpages generated in HyperText Markup Language (HTML) or other language. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and/or the like, including elements comprising or derived from data stored in one or more databases (not shown) that are locally and/or remotely accessible to platform 110. Platform 110 may also respond to other requests from user system(s) 130.

Platform 110 may further comprise, be communicatively coupled with, or otherwise have access to one or more database(s) 112. For example, platform 110 may comprise one or more database servers which manage one or more databases 112. A user system 130 or application executing on platform 110 may submit data (e.g., user data, form data, etc.) to be stored in the database(s) 112, and/or request access to data stored in such database(s) 112. Any suitable database may be utilized, including without limitation MySQL™, Oracle™, IBM™, Microsoft SQL™, Sybase™, Access™, and/or the like, including cloud-based database instances and proprietary databases. Data may be sent to platform 110, for instance, using the well-known POST request supported by HTTP, via FTP, etc. This data, as well as other requests, may be handled, for example, by server-side web technology, such as a servlet or other software module, executed by platform 110.

In embodiments in which a web service is provided, platform 110 may receive requests from user system(s) 130, and provide responses in eXtensible Markup Language (XML) and/or any other suitable or desired format. In such embodiments, platform 110 may provide an application programming interface (API) which defines the manner in which user system(s) 130 may interact with the web service. Thus, user system(s) 130, which may themselves be servers, can define their own user interfaces, and rely on the web service to implement or otherwise provide the backend processes, methods, functionality, storage, etc., described herein. For example, in such an embodiment, a client application executing on one or more user system(s) 130 may interact with a server application executing on platform 110 to execute one or more or a portion of one or more of the various functions, processes, methods, and/or software modules described herein. The client application may be “thin,” in which case processing is primarily carried out server-side by platform 110. A basic example of a thin client application is a browser application, which simply requests, receives, and renders web pages at user system(s) 130, while platform 110 is responsible for generating the web pages and managing database functions. Alternatively, the client application may be “thick,” in which case processing is primarily carried out client-side by user system(s) 130. It should be understood that the client application may perform an amount of processing, relative to platform 110, at any point along this spectrum between “thin” and “thick,” depending on the design goals of the particular implementation. In any case, the application, which may wholly reside on either platform 110 or user system(s) 130 or be distributed between platform 110 and user system(s) 130, can comprise one or more executable software modules that implement one or more of the processes, methods, or functions of the application(s) described herein.

2. Process Overview

Embodiments of processes for facilitating requests, quotations, and/or purchases of insurance will now be described in detail with reference to example user interfaces. It should be understood that the described processes may be embodied in one or more software modules that are executed by one or more hardware processors, e.g., as the application discussed above, which may be executed wholly by processor(s) of platform 110, wholly by processor(s) of user system(s) 130, or may be distributed across platform 110 and user system(s) 130 such that some portions or modules of the application are executed by platform 110 and other portions or modules of the application are executed by user system(s) 130. The described process may implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

It should be understood that, while the processes, user interfaces, and other features discussed herein will be described primarily with reference to insurance sought by businesses, many, if not all of, the processes are equally applicable to embodiments in which the insurance is sought by individuals or a mixture of businesses and individuals. Thus, the term “business-user” as used herein should be read to encompass both users representing businesses in the acquisition of business-related insurance and users representing themselves or others in the acquisition of personal insurance.

2.1. Example User Interfaces

Some example user interfaces that may be applicable to processes discussed herein will now be described. As illustrated in many of the figures, any of the user interfaces may comprise help information and/or inputs for viewing help information (e.g., links to pop-ups) may be provided to guide the user through the process of filling out and navigating the user interfaces.

2.1.1. Agent Registration User Interface

FIGS. 2A-2F illustrate an agent registration process, according to an embodiment. The agent registration process may be implemented as a wizard that steps an insurance agent through a series of user interfaces designed to collect information from and about the agent-user and/or agency. In the illustrated embodiment, the wizard guides a registering agent through five sets of sequential user interfaces designed to collect (1) user information, (2) an agent profile, (3) lead preferences, (4) agency information, and (5) payment information. The agent-user may proceed from a current user interface to a subsequent user interface, if any, using an input (e.g., an icon, link, or button which posts form data), which, when selected, accumulates the information received in the current user interface with any information received in previous user interfaces. Similarly, the agent-user may also return from a current user interface to a prior user interface, if any. It should be understood that less, additional, or different information may be collected and/or fewer or more sets of user interfaces may be used.

FIG. 2A illustrates a user interface comprising inputs for collecting user information for an insurance agent, according to an embodiment. This user information may comprise a agent-user's first name, last name, contact information (e.g., email address, phone number, phone number extension), password (which may be used in conjunction with the agent-user's email address, or a separate user identifier entered into an additional field (not shown), as the agent-user's login credentials), password confirmation (i.e., to verify the entered password), insurance license number, and/or the like.

FIG. 2B illustrates a user interface comprising inputs for collecting an agent profile for an insurance agent, according to an embodiment. This agent profile may comprise the agent's number of years of experience, the agent's book premium, the average premium of the agent's clients, the average number of employees for the agent's clients, the average annual sales for the agent's clients, and/or the like. As illustrated, one or more, including all, of these inputs may comprise drop-down or pop-up menus from which one of a plurality of options (e.g., a single value from multiple values, a single range of values from multiple ranges of values, etc.) may be selected.

FIG. 2C illustrates a user interface comprising inputs for collecting lead preferences for an insurance agent, according to an embodiment. The collected lead preference data may comprise one or more preferred policy types, one or more lead categories, one or more states, and one or more counties for each state. As illustrated, one or more, including all, of these inputs may comprise drop-down or pop-up menus from which one or multiple options may be selected from a plurality of options. The lead categories may comprise proprietary or standard industry classifications, which may be searchable and/or browsable (e.g., by selecting a link or other input which initiates a pop-up user interface that allows a user to add selected categories to a list of accumulated categories). States and/or counties may also be selectable and/or browsable in the same or similar manner. The collected lead preferences for an insurance agent may be used to filter insurance requests submitted by businesses, so that the insurance agent is primarily provided (or only provided) with insurance requests that meet some or all of the lead preferences.

FIG. 2D illustrates a user interface comprising inputs for collecting agency information for an insurance agent, according to an embodiment. This agency information may comprise a name of the agency, an address of the agency (e.g., street, city, state, Zip code, and/or county), a premium volume (e.g., a range), a number of direct carrier appointments, a number of MGA/wholesale/surplus appointments, number of agents employed by the agency, a primary representation (e.g., local, state, national, etc.), number of agency locations, and/or the like. Again, one or more of these inputs may comprise drop-down or pop-up menus from which one or multiple options may be selected from a plurality of options.

FIG. 2E illustrates a user interface comprising inputs for collecting payment information for an insurance agent, according to an embodiment. This payment information may comprise a name on a credit card, credit card number, expiration date for the credit card (e.g., month and year), and Card Verification Code (CVC) for the credit card. It should be understood that this is simply one example, and that the payment information may comprise additional or alternative information (e.g., bank account number and routing number, PayPal® information, etc.). Alternatively, payment information may not be required during the agent registration process.

The final information-collection user interface in the agent registration process—the user interface in FIG. 2E, in the illustrated example—may comprise an input (e.g., icon, link, or button) for completing the registration process and generating a agent-user account with the platform (e.g., platform 110). When selected, the input may direct the agent-user to a primary dashboard user interface for the agent-user's account, as depicted in FIG. 2F, according to an embodiment. This dashboard may be the primary user interface that the agent-user will see when the agent-user first logs in to the account, and from which the agent-user can view and manage leads (i.e., request for insurance from business-users, quotations for insurance to business-users), messages (e.g., with business-users), statistics (e.g., number of leads, number of quotations provided, number of quotations accepted, etc.), and/or the like. As shown in FIG. 2F, when the dashboard is initially shown to an agent-user (e.g., after completion of the agent registration process), the agent-user may be prompted to get acquainted with the platform by taking a virtual tour. The virtual tour may be a video, animation, demonstration, presentation, etc. that educates the agent-user about the various features of the platform.

2.1.2. Agent Dashboard User Interface

FIG. 3 illustrates a populated dashboard user interface for an agent, according to an embodiment. In an embodiment, the dashboard user interface comprises three primary areas, regions, panels, or frames: (1) a leads section 310, (2) a messages section 320, and (3) a statistics section 330. However, it should be understood that the dashboard user interface may comprise fewer, more, or different sections than the three illustrated sections.

In an embodiment, leads section 310 comprises a list of requests for insurance received by the platform and forwarded by the platform to the agent-user. The list of requests may comprise a row, comprising information and/or inputs, for each request for insurance forwarded to the user-agent. In the illustrated embodiment, each row represents a single request for insurance and comprises an identifier (e.g., name) of the business-user seeking insurance, the type of insurance being sought (e.g., workers compensation, general liability, errors and omissions, privacy/data breach, etc.), the date on which the request for insurance was received (either at the platform or at the account of the agent-user), the date on which the start of coverage is sought and/or on or by which a quotation is sought, a status of the request for insurance (active, selected, withdrawn, etc.), an award status (e.g., won, lost, etc.), an input (e.g., icon, link, or button) for reviewing the request for insurance, and an input for reviewing and/or editing a quotation for the request prepared by the agent-user and/or in the process of being prepared by the agent-user.

In the illustrated example, leads section 310 lists three active requests 310A, 310B, and 310C and one request 310D with a selected status. Of the three active requests, the agent-user has not yet submitted a quotation for requests 310A and 310B, both of which were received on Feb. 26, 2014, and therefore, for each of these requests 310A and 310B, is provided with an input for creating or editing a quotation. With respect to request 310C, which was received on Feb. 21, 2014, the agent-user submitted a quotation on Feb. 21, 2014. However, the business-user who submitted request 310C and to whom the quotation was submitted has not yet selected an agent-user. Thus, request 310C remains active. On the other hand, request 310D is no longer active. With respect to request 310D, the request was received from the business-user on Dec. 16, 2013 and the agent-user submitted a quotation on Feb. 20, 2014. Subsequently, the business-user selected the agent-user based on this quotation, as indicated by the award status of “won.” If the business-user had, instead, selected a different agent-user than the agent-user whose dashboard user interface is being illustrated, the award status would be indicated in the negative (e.g., “lost”).

In an embodiment, messages section 320 comprises a list of messages sent between the agent-user and one or more business-users and/or the agent-user and the platform. This is similar to a web-based email system, but may be implemented as an internal messaging system of the platform. In some embodiments, multiple user-agents may be associated with a single agency. In such embodiments, each user-agent associated with the agency may be able to view messages sent by or to the other user-agents associated with the agency. In addition, in some embodiments, there may be public messages between a business-user and an agent-user, with respect to a request for insurance, which are visible to other agent-users who are preparing quotations for the same request. This allows for clarifications and other information related to the request to be disseminated quickly and efficiently to all interested parties.

In the illustrated example, messages section 320 comprises a row for each message visible to the agent-user. Each row comprises identifiers of the sender and recipient, an identifier of the request for insurance to which the message pertains, a subject or snippet thereof, a body of the message or snippet thereof, and the date and/or time that the message was sent or received. As illustrated, the messages may comprise messages or notifications sent from an agent-user to a business-user, a business-user to an agent-user, and/or the platform to an agent-user. It should be understood that, while all of the messages in the illustrated example are shown in the same mailbox, in other embodiments, separate mailboxes or message folders may be provided (e.g., inbox, sent items, deleted items, user-specified folders, etc.). In addition, messages section 320 comprises an input for composing a new message. When the input is selected, the user may be directed to a user interface (e.g., as a separate webpage or pop-up) for composing a message (e.g., comprising inputs for selecting or entering a recipient user, pertinent request for insurance, subject line, message body, etc.).

In an embodiment, statistics section 330 presents one or more statistics that may be relevant to an agent-user. For example, these statistics may comprise the number of total leads that an agent-user has received, the number of requests for which the agent-user has submitted a quotation, the percentage of requests for which the agent-user has submitted a quotation relative to the number of requests received by the agent-user, the number of times that the agent-user or the agent-user's quotations have been selected by a business-user, the percentage of quotations that have been selected by business-users relative to the number of quotations submitted by the agent-user, etc. These statistics may be presented in text (e.g., labels and numbers) and/or graph form (e.g., pie chart, bar chart, etc.).

2.1.3. Agent Request-Specific User Interface

FIGS. 4A-4C illustrate a set of user interfaces through which an agent-user may review and generate a quotation for a particular request for insurance (or “lead”), according to an embodiment.

FIG. 4A illustrates a user interface that acts as a private request-specific workspace for an agent-user to review a particular request for insurance and generate a quotation for that request, according to an embodiment. In an embodiment, this workspace user interface comprises four primary areas, regions, panels, or frames: (1) a request-details section 410, (2) a quote-summary section 420, (3) a notifications section 430, and (4) a loss-history section 440. However, it should be understood that the workspace user interface may comprise fewer, more, or different sections than the four illustrated sections.

In an embodiment, request-details section 410 comprises information about the particular request for insurance, similar in nature to the information supplied in each row in the list of requests in leads section 310. For example, the information in request-details section 410 may comprise an identifier (e.g., name) of the business-user that has submitted the request, the type of insurance requested (e.g., workers compensation), the status of the request, the effective of the desired insurance policy, the cut-off or expiration date for submitting quotations, a unique reference number or identifier associated with the request (e.g., a unique identifier that is utilized across the entire platform to identify the request), and/or the like.

In an embodiment, quote-summary section 420 comprises summary information about the quotation that has been submitted, prepared, or is in the process of being prepared for the request for insurance. For example, the information in quote-summary section 420 may comprise an identifier (e.g., name) of the insurance carrier that will provide the insurance, the premium amount for the quoted insurance policy, the status of the quotation (e.g., not begun, draft, complete, submitted, selected, purchased, etc.), and a list of attachments, if any (e.g., electronic documents attached to the quotation). The quote-summary section 420 may also comprise an input (e.g., icon, link, button, etc.) for creating and/or editing a quotation for the request (which may be in addition to standard navigation on the user interface).

In an embodiment, notifications section 430 is similar in format to messages section 320, in that it allows an agent-user to compose a message and comprises rows of messages, if any, which specify, for each message, a sender and recipient, a subject or snippet thereof, a body of the message or snippet thereof, and a date and/or time that the message was received. However, notifications section 430 may differ from messages section 320 in that it only includes notifications about the particular request sent by the platform and/or messages regarding the particular request for insurance to which the user interface pertains. Accordingly, it is not necessary to provide an identifier of the request for insurance associated with each message as provided in messages section 320.

In an embodiment, loss history section 440 comprises information related to a pertinent loss history, if any, for the business-user that submitted the request for insurance. As discussed in greater detail elsewhere herein, the loss history may comprise a list of documents and associated information related to a loss or losses experienced by the business-user that submitted the request.

FIG. 4B illustrates a user interface that provides more detailed information about the request for insurance, according to an embodiment. This detailed information may correspond to information collected from the business-user requesting the insurance during the request generation process, which is described in greater detail elsewhere herein. Specifically, during the request generation process, the platform may provide the business-user with one or more user interfaces that collect one or more categories of information regarding the request for insurance. This collected information may then be provided to the agent-user (e.g., in the form of the user interface in FIG. 4B) for review by the agent-user when drafting the insurance quotation. As illustrated, the user interface may comprise input for navigating through, listing, browsing, and/or printing the collected information.

FIG. 4C illustrates a user interface for generating a quotation for the request for insurance, according to an embodiment. Specifically, the user interface comprises inputs which allow an agent-user to specify (enter or select) details of the quotation. While FIG. 4C illustrates a user interface specifically for generating a quotation for a request for worker's compensation insurance, it should be understood that similar, but separate, user interfaces can be used for generating a quotation for other types of insurance (e.g., general liability, errors and omissions, privacy/data breach, etc.).

In the illustrated user interface, a row of inputs is provided for each of one or more insurance class codes submitted by the business-user. In the illustrated context of workers compensation insurance, each class code represents a payroll or worker class. Thus, each row comprises an identification of the class code provided by the business-user, the estimated payroll (or other rating basis) provided by the business-user, an input for specifying the payroll (or other rating basis) which, by default, may be prepopulated with the estimated payroll provided by the business-user, an input for specifying the net rate used to calculate the premium, an input for specifying the premium which may be automatically calculated based on the payroll input and net rate input (e.g., using a script, such as Javascript), and any comments that the agent-user may wish to add (which may be private to the agent-user or provided to the business-user when the quotation is submitted, depending on the implementation).

Notably, in an embodiment, the agent-user is required to provide the net rate for each class code, placing the onus on the agent-user to calculate the net rate(s) for the policy quotation. However, in an embodiment, the platform may comprise a net-rate calculator, which provides the agent-user with a user interface comprising inputs for values needed to calculate a net rate (e.g., base rate, experience rating modifier, schedule rating factor, premium discount factor, etc.) and calculates the net rate based on the specified inputs.

As illustrated in FIG. 4C, an input (e.g., icon, link, button, etc.) is also provided in the user interface which allows the agent-user to add an additional row or record (e.g. payroll record in the context of workers compensation). For example, the agent-user may wish to utilize one or more class codes for the quotation that are different than those specified by the business-user that submitted the request. In this case, the agent-user can select the input, which will add an additional row of inputs into which the user may specify or enter the desired class code, payroll amount, net rate, premium, and/or comments. As is discussed in greater detail elsewhere herein, the business-user who receives the quotation, once submitted by the agent-user, will be able to view each record (e.g., payroll record with associated class code) relied upon by the agent-user for the quotation. Advantageously, this ensures transparency in the quotation process and allows for a more effective comparison of quotations by the business-user.

In an embodiment, if an agent-user modifies any of the information provided by the business-user in the request for insurance (e.g., class codes, rating basis, etc.), the agent-user may be required to provide a comment (e.g., via a text input) stating the reason(s) why the agent-user has deviated from the information provided in the request. This ensures that the agent-user cannot hide flaws in its quotation in order to provide a lower premium for the quotation.

The user interface illustrated in FIG. 4C also includes one or more inputs for specifying an amount (or other basis, such as a percentage) for applicable taxes and/or fees. The user interface then calculates and displays a total (e.g., using a script) based on the premium for each class code and the specified taxes and fees. Although not shown, the user interface may also comprise an input for submitting the quotation, i.e., sending the quotation for review and possible selection by the business-user that submitted the associated request for insurance.

2.1.4. Business Registration User Interface

FIGS. 5A-5C illustrate a business registration process, according to an embodiment. As with the agent registration process, the business registration process may be implemented as a wizard that steps a business (or individual) through a series of user interfaces designed to collect information from and about the business-user and/or business. In the illustrated embodiment, the wizard guides a registering business through three sets of sequential user interfaces designed to collect (1) user information, (2) business information, and (3) confirmation by the business-user. The business-user may proceed from a current user interface to a subsequent user interface, if any, using an input (e.g., an icon, link, or button which posts form data), which, when selected, accumulates the information received in the current user interface with any information received in previous user interfaces. Similarly, the business-user may also return from a current user interface to a prior user interface, if any. It should be understood that less, additional, or different information may be collected and/or fewer or more sets of user interfaces may be used.

FIG. 5A illustrates a user interface comprising inputs for collecting user information for a business-user, according to an embodiment. This user information may comprise a business-user's first name, last name, contact information (e.g., email address, phone number, phone number extension), password (which may be used in conjunction with the business-user's email address, or a separate user identifier entered into an additional field (not shown), as the business-user's login credentials), password confirmation (i.e., to verify the entered password), and/or the like.

FIG. 5B illustrates a user interface comprising inputs for collecting a business profile for the business representing by the business-user, according to an embodiment. This business profile may comprise the name of the business, website address of the business, mailing address of the business (e.g., street, city, state, Zip code), and/or the like.

FIG. 5C illustrates a user interface for confirming or validating the business-user, which may be required by the platform before the business-user can complete registration, according to an embodiment. For instance, an email message, comprising a confirmation code (and optionally a link to the confirmation user interface), can be sent to the email address specified by the business-user (e.g., in the user interface illustrated in FIG. 5A). In order to complete registration, the business-user may then be required to enter the confirmation code (or click the link) into an input on the user interface and select an input for completing registration. If the confirmation number does not match the one sent to the business-user's specified email, registration may be denied, as the user may be attempting to register with the platform using an invalid or false email address. It should be understood that other forms of communication may be used during the validation process in addition to or as an alternative to email. For instance, an automated or manual call may be placed to a telephone number provided by the business-user during the registration process with a confirmation code for entering into the user interface, or the business-user may be required to enter a confirmation code that was previously provided to the business-user using the telephone number pad or by speaking into the telephone once the call is picked up by the business-user.

Once a business-user has registered with the platform, the business-user may login using associated login credentials (e.g., email and password specified in the user interface illustrated in FIG. 5A). FIG. 5D illustrates an example user interface for authenticating with the platform using a user's associated credentials. This login or authentication user interface may be the same for both agent-users and business-users even though the different types of users are associated with different roles and functions once authenticated.

Once a business-user logs in (e.g., using the authentication user interface illustrated in FIG. 5D), the business-user may be provided with a dashboard user interface, which serves as the primary user interface that the business-user will see when the business-user first logs into the business-user's account, as depicted in FIG. 5E, and from which the business-user can view and manage requests and quotations for insurance, messages with agents, insurance renewals, preferred or incumbent agents, and/or the like. As shown in FIG. 5E, when the dashboard is initially shown to a business-user (e.g., after completion of the business registration process), the business-user may be prompted to get acquainted with the platform by taking a virtual tour. The virtual tour may be a video, animation, demonstration, presentation, etc. that educates the agent-user about the various features of the platform. Alternatively or additionally, the business-user may be prompted to create a new request for insurance (RFI).

2.1.5. Business Dashboard User Interface

FIG. 6 illustrates a populated dashboard user interface for a business, according to an embodiment. In an embodiment, the dashboard user interface comprises four primary areas, regions, panels, or frames: (1) a requests section 610, (2) a messages section 620, (3) a calendar section 630, and (4) an agents section 640. However, it should be understood that the dashboard user interface may comprise fewer, more, or different sections than the four illustrated sections.

In an embodiment, requests section 610 comprises a list of requests for insurance prepared, being prepared, or submitted to the platform by the business-user. In some embodiments, only active requests for insurance may be listed in requests section 610. The list of requests may comprise, comprising information and/or inputs, for each (active) request for insurance prepared, being prepared, or submitted by the business-user. In the illustrated embodiment, each row represents a single request for insurance and comprises an identifier of the type of insurance being requested, a unique identifier of the request, a status of the request (e.g., draft, submitted, quoted, accepted, etc.), a policy date being sought, the number of insurance agents to whom the request was sent, the number of insurance agents from whom a quotation has been received, an input for editing or deleting the request if it has not yet been submitted, an input for viewing the request if submitted, an input for viewing quotations received for the request if submitted, and/or the like. In addition, requests section 610 may comprise an input (e.g., icon, link, button, etc.) for beginning a new request for insurance (e.g., that redirects the business-user to the user interfaces, such as those illustrated in FIGS. 8A-8H, for generating a new request for insurance).

In the illustrated example, requests section 610 lists two active requests 610A and 610B. Of the active requests, the business-user has not yet submitted the request 610A, as indicated by the status of “draft.” Request 610A seeks workers compensation insurance with a policy date of Apr. 11, 2014. Since, request 610A has not yet been submitted by the business-user, it has not been forwarded to any agent-users, has not received any quotations, and the row for request 610A still comprises inputs for editing and deleting the request. Request 610B, on the other hand, has been submitted by the business-user, as indicated by the status of “submitted.” Accordingly, request 610B has been forwarded, by the platform, to four agent-users, but no quotations have yet been received. If or when a quotation is received for request 610B, the number of quotations displayed may be increased by one, and the status of request 610B may be changed (e.g., to “quoted”). Once one of the quotations is accepted by the business-user, the status of request 610B may again be changed (e.g., to “accepted”). The number and identity of the agents to which requests are forwarded may be determined by the platform and/or business-user as discussed elsewhere herein. Since, request 610B has been submitted, the row for request 610B does not comprise inputs for editing or deleting the request, but does comprise inputs for viewing the request and quotations, if any, associated with the request.

In an embodiment, messages section 620 is identical to messages section 320, except that it comprises a list of messages sent between the business-user and one or more agent-users and/or the business-user and the platform. In the illustrated example, message section 620 comprises a row for each message visible to the business-user. Each row comprises identifiers of the sender and recipient, an identifier of the request for insurance to which the message pertains, a subject or snippet thereof, a body of the message or snippet thereof, and the date and/or time that the message was sent or received. As illustrated, the messages may comprise messages or notifications sent from an agent-user to a business-user, a business-user to an agent-user, and/or the platform to a business-user. It should be understood that, while all of the messages in the illustrated example are shown in the same mailbox, in other embodiments, separate mailboxes or message folders may be provided (e.g., inbox, sent items, deleted items, user-specified folders, etc.). In addition, message section 620 comprises an input for composing a new message. When the input is selected, the user may be directed to a user interface (e.g., as a separate webpage or pop-up) for composing a message (e.g., comprising inputs for selecting or entering a recipient user, pertinent request for insurance, subject line, message body, etc.).

In an embodiment, calendar section 630 comprises a list of upcoming events or reminders relevant to a business-user. For example, calendar section 630 may comprise a list of reminders about expiring insurance policies. As illustrated in FIG. 6, the list of reminders comprises a row for each insurance policy purchased by the business-user that includes the number of days until the policy expires and an identifier of the insurance policy and/or the type of insurance policy. It should be understood that less, additional, or different information may be provided than illustrated in FIG. 6. For instance, instead of a time until expiration, a date of expiration may be provided. Furthermore, other upcoming events, besides policy expirations, may also be listed (e.g., expiration of quotations for insurance, expiration of a request for insurance, expiration of a time to select an insurance policy, etc.). In some embodiments, in addition to or as an alternative to the reminders in calendar section 630, notifications may be sent to the business-user (e.g., via email message and/or text message, automated telephone call, etc.) with reminders of upcoming dates or deadlines. In either case, the reminders, whether by calendar section 630 or by other communication to the business-user, may act as a starting point to the request for insurance process for an insurance policy that is coming up for renewal. The reminders may automatically begin at a certain time period preceding the renewal deadline (e.g., ninety days prior to the deadline), and business-users may be provided with an input for placing the reminders in a “snooze” mode for a certain period of time and/or until a certain time remains until the deadline (e.g., “remind me in ten more days,” “remind me ten days prior to the deadline,” etc.).

In an embodiment, agents section 640 comprises a list of agent-users that are related to the business-user in one or more ways. For example, the list may comprise agent-users that the business-user has selected as favorites, agent-users from whom the business-user has purchased insurance, a certain number of agent-users from whom the business-user has purchased insurance, etc. In any case, the list may comprise, for each agent-user, an identifier of the agent-user (e.g., name), an identifier of the agency (e.g., name) with whom the agent-user is associated, an input (e.g., icon, link, button, etc.) for viewing additional information about the agent-user (e.g., contact information), an input for contacting the agent-user (e.g., sending a message or email to the agent-user), and/or the like.

2.1.6. Request Generation User Interface

FIGS. 7A-7C illustrate an initial set of user interface(s) for generating a new request for insurance, according to an embodiment. This initial set of user interface(s) provide inputs and receive initial responses from a business-user that are used to generate or retrieve a subsequent set of user interface(s) which collect information that is appropriate to a specific type of policy and industry. It should be understood that while the initial set of user interfaces are illustrated as three separate pop-ups over the business dashboard user interface, these user interfaces may alternatively be implemented as their own web page(s), as fewer user interfaces (e.g., one or two user interfaces), as more user interfaces, together with the subsequent set of user interface(s), and/or comprising inputs that collect less, additional, or different information. The illustrated initial set of user interfaces utilize, but are not limited to, a wizard format, in which a business-user may proceed from a current user interface to a subsequent user interface, if any, and vice versa.

FIG. 7A illustrates a first, initial user interface comprising input(s) through which a business-user can identify the type of policy sought, according to an embodiment. In an embodiment, the policy type can be selected from a plurality of supported policy types using a selection input, such as a set of labeled radio buttons or checkboxes or a drop-down menu. While the illustrated user interface only permits a business-user to select one type of insurance policy, in alternative embodiments, a business-user may be permitted to select multiple insurance policies in a single request for insurance. Once the business-user has selected the desired insurance policy or policies for the request for insurance, the user may proceed to the second, initial user interface.

FIG. 7B illustrates the second, initial user interface comprising input(s) for specifying an industry or industries for which the insurance policy is being sought (e.g., by entering a description of the industry and/or selecting an industry from an pop-up or drop-down menu), according to an embodiment. Once the business-user has specified the industry, the user may proceed to the third, initial user interface.

FIG. 7C illustrates the third, initial user interface comprising a list of the information specified in the preceding two initial user interfaces (i.e., policy type(s) and industry(ies)), and optionally additional information, according to an embodiment. The third user interface may also prompt the business-user to proceed to start the request for insurance, i.e., move to a subsequent set of user interfaces configured to collect policy-specific, industry-specific, and other request-specific information. For example, if the business-user selects an input on the user interface, the platform may retrieve and/or generate one or more user interfaces based on the user-specified policy type(s) and industry(ies). Specifically, these request-specific user interface(s) may comprise inputs for collecting additional information from the business-user about the desired insurance policy, including inputs that are specifically configured to collect information that relate only to the particular type(s) of insurance policy specified and/or the particular industry(ies) specified. However, it should be understood that these user-interfaces may also comprise general inputs that are configured to collect information that relate to all policies and/or industries or groups of policy types and/or industries that include the specified policy type(s) and industry(ies).

FIGS. 8A-8H illustrate an example set of user interfaces that may be presented to a business-user after the business-user has specified the desired policy type(s) and/or industry(ies), according to an embodiment. While these user interfaces are specific to the context of workers compensation insurance, it should be understood that the user interfaces may be similarly configured for other types of insurance. It should also be understood that these user interfaces may alternatively be implemented as fewer user interfaces (e.g., including one user interface), as more user interfaces, together with the initial set of user interface(s), and/or comprising inputs that collect less, additional, or different information. Furthermore, the same set of user interfaces may be presented both for the initial creation of a request for insurance, as well as for modification of a previously-generated request for insurance (e.g., with prepopulated inputs).

The illustrated set of user interfaces utilize, but are not limited to, a wizard format, in which a business-user may proceed from a current user interface to a subsequent user interface, if any, and vice versa. In addition, each user interface may comprise an input (e.g., icon, link, button, etc.) for saving the request as a draft and/or printing the request. In the illustrated embodiment, the wizard guides the business-user through six sets of sequential user interfaces designed to collect (1) business information, (2) policy-specific information (e.g., payroll information), (3) general information, (4) industry-specific information, (5) loss history, and (6) confirmation to submit the request. As each section of the wizard is completed, an indication may be provided on a header or navigation menu so that a business-user can easily see progress through the wizard. At least some of the inputs on these user interfaces may be prepopulated with information that has been previously been collected from the business-user, such as general business information (e.g., mailing address, website address, industry, product or service, federal employer identification number (FEIN), etc.).

FIG. 8A illustrates a user interface comprising inputs for collecting business information from a business-user for the request for insurance, according to an embodiment. This business information may comprise the address of the business (street, city, state, Zip code, county, etc.), an industry type, description of the business' product or service, website address, FEIN or Social Security number (SSN), whether a new policy is being requested or a policy is being requested to replace an existing policy, the desired policy start date, and/or the like.

FIG. 8B illustrates a user interface comprising inputs for collecting policy-specific information from the business-user for the request for insurance, according to an embodiment. In the illustrated example, the business-user has requested a workers compensation policy. Therefore, the user interface comprises labels and inputs that are specific to a workers compensation policy. For example, the user interface may comprise an initial tab for an initial business location (e.g., a primary location) with an input for adding additional tabs for additional business locations (e.g., secondary locations). Each tab may comprise the same inputs. For example, for each location (e.g., on each tab), the user may specify a business location for the workers compensation policy, as well as a nickname for the location (e.g., for easier future reference). In addition, an input may be provided to specify whether there is payroll for the location. If so, the business-user may create a record for each insurance class code to be included in the request. Each record may be added as a row to the user interface (e.g., by selecting an input which results in the generation of a new row of inputs). Each row comprises inputs for specifying (e.g., entering or selecting from a pop-up or drop-down menu) a class code, specifying a payroll amount, specifying a number of full-time employees, specifying a number of part-time employees, deleting the row, and/or the like.

FIG. 8C illustrates a user interface comprising inputs for collecting general information from the business-user for the request for insurance, according to an embodiment. The general information collected may comprise information about employee benefits (e.g., whether a group medical plan is provided, whether a return-to-work program is in place, etc.), hiring practices (e.g., whether written applications are required, whether reference checks are performed, whether an employee orientation program is in place, whether pre- or post-employment physicals are required, whether and when drug testing is performed, whether formal job descriptions are kept on file, etc.), safety information (e.g., whether and what employee safety training is performed, whether job-specific training is provided, whether formal written accident reports are kept, whether there is an active safety program, whether and how often safety meetings are conducted, the maximum height at which employees will work, etc.), and operations information (e.g., whether there is driving/delivery exposure, hours of operation, number of work shifts, etc.). In the illustrated example, there is a submenu for jumping to the different subsections (e.g., employee benefits, hiring practices, safety, and operations) of the user interface.

FIG. 8D illustrates a user interface comprising inputs for collecting industry-specific information from the business-user for the request for insurance, according to an embodiment. The illustrated example is for non-construction contractors. It should be understood that this user interface will differ according to the type of industry specified for the request for insurance (e.g., in the initial set of user interfaces for requesting insurance).

FIG. 8E illustrates a user interface comprising inputs for collecting a loss history, if any, from the business-user for the request for insurance, according to an embodiment. In the illustrated example of FIG. 8E, the business-user is prompted to select one of a plurality of options (e.g., using a radio button) indicating that either the business-user has had previous losses and will attach a loss history, has had previous losses but will attach a loss history later, has no previous losses, or has had no policy in the last three years (or some other time period). If the business-user indicated that there is a previous loss, an input (e.g., icon, link, button, etc.) may be provided for uploading one or more documents, which are stored in association with (i.e., “attached”) to the request for insurance. If the business-user indicated that there is a previous loss, but that the loss history will be attached later, this attachment of document(s) may occur at a later time (e.g., by the business-user subsequently editing the request).

FIG. 8F illustrates a user interface comprising inputs for submitting the request for insurance by the business-user, according to an embodiment. In an embodiment, an input (e.g., textbox) is provided that is configured to receive any additional information, instructions, or comments that the business-user wishes to be communicated with the request for insurance. An input is also provided for submitting the request for insurance. In some embodiments, the user interface may also comprise an input for inviting an agent (registered and/or unregistered) to participate in the quotation process, as discussed in greater detail elsewhere herein. For example, for an agent that is registered with the platform, the input may allow the business-user to select from a directory of agent-users and/or select an incumbent agent-user (i.e., an agent-user that provided a prior insurance policy to the business-user). For an agent that is not registered with the platform, the input may allow the business-user to provide an email address and/or additional or different contact information (e.g., mailing address, telephone number, fax number, etc.), as well as other information (e.g., name), and the platform may send an invitation to the agent using the email address or other contact information and/or additional information.

FIGS. 8G and 8H illustrate user interfaces (e.g., pop-ups) that may be presented to the business-user after selecting the input for submitting the request for insurance illustrated in FIG. 8F. The first user interface, as illustrated in FIG. 8G, may prompt the business-user for confirmation that the request for insurance should be submitted. The prompt may comprise a warning that the business-user will not be able to make modifications once the request has been submitted, and inputs (e.g., icons, links, buttons, etc.) for canceling and/or confirming the submission. If the business-user chooses to cancel the submission, the business-user may be returned to the user interface illustrated in FIG. 8F. Otherwise, if the business-user confirms submission of the request, the business-user may be shown the user interface, illustrated in FIG. 8H, which confirms that the request has been submitted and may provide additional information (e.g., information about what to expect post-submission) to the business-user.

Once the business-user has completed and submitted a request for insurance to the platform (e.g., using the interfaces described above), the request may be forwarded to a number of agent-users, who may be selected or otherwise determined by the platform and/or the business-user as described elsewhere herein.

2.1.7. Business Request-Specific User Interface

FIGS. 10A and 10B illustrate user interfaces that enable a business-user to manage quotations for a particular request for insurance, according to an embodiment.

FIG. 10A illustrates a user interface that acts as a private request-specific workspace for a business-user to review a particular request for insurance, including quotations submitted for the request, according to an embodiment. In an embodiment, this workspace user interface comprises four primary areas, regions, panels, or frames: (1) a quotations section 1010, (2) a messages section, 1020, (3) a loss-history section 1030, and (4) an agents section 1040. However, it should be understood that the workspace user interface may comprise fewer, more, or different sections than the four illustrated sections.

In an embodiment, quotations section 1010 comprises information about agents to whom the request for insurance was forwarded and a quotation, if any, submitted by each of those agents. The quotations section 1010 may comprise a list comprising a row for each agent-user to whom the request was forwarded. Each row may comprise an identifier (e.g., name) of the agent-user, an identifier (e.g., name) of the agency associated with the agent-user, and, if a quotation has been submitted by the agent-user, the insurance carrier for the quoted insurance policy, the date and/or time that the quotation was submitted or received, the amount of the quoted premium, input(s) for available action(s), such as viewing or approving or accepting the quotation, a list of attachments or inputs for viewing attachments, if any, and/or the like. As illustrated, the quotations section 1010 shows quotations have been received from three agent-users (including the agent-user associated with row 1010A), but that quotations have not yet been received from three other agent-users (including the agent-user associated with row 1010B). Quotations section 1010 may also comprise an input (e.g., icon, link, button, etc.) for accessing a quote analyzer user interface, which is described in more detail elsewhere herein.

If a business-user selects an approval input in a row of the quotations section 1010 associated with a particular quotation, the user interface in FIG. 10B (e.g., illustrated as a pop-up frame) may be provided to confirm that the business-user wishes to select the quotation. This user interface may prompt the business-user to either cancel the acceptance of the quotation by selecting a cancellation input or confirm the acceptance of the quotation by selecting an input associated with confirming acceptance. The user interface may also warn the business-user that accepting the quotation will decline all other quotations submitted for the request. If the business-user chooses to cancel the acceptance of the quotation, the business-user can be returned to FIG. 10A. Otherwise, if the business-user proceeds to accept the quotation, the business-user may be directed to FIG. 10C.

FIG. 10C illustrates the user interface from FIG. 10A after quotation 1010A has been accepted (e.g., by selecting an approval input of quotations section 1010 in a row associated with quotation 1010A). Notably, the status of the request for insurance has been changed to “accepted,” as indicated in a request details portion which may be common to all of the request-specific user interfaces. In addition, the inputs for accepting or approving the quotations in quotations section 1010 have all been automatically replaced, by the platform, with a status indication. Specifically, quotation 1010A is indicated as “awarded,” and the remaining quotations 1010C (e.g., including rows associated with agent-users who have not submitted quotations) are indicated as “declined.” When a quotation is awarded or declined, the platform may send a notification to each agent-user involved informing that agent-user that the agent-user's quotation has been accepted or declined. Thus, in the illustrated example, the agent-user associated with quotation 1010A would receive a message (e.g., in the agent-user's messages section 320 and notifications section 430 for the request) notifying the agent-user that its quotation has been accepted. On the other hand, each agent-user associated with one of the quotations 1010C and/or received the request but failed to submit a quotation would receive a message (e.g., in the agent-user's messages section 320 and notifications section 430 for the request) notifying the agent-user that its quotation has been declined.

In an embodiment, messages section 1020 is similar in format to the messages section 620, in that it allows the business-user to compose a message and comprises rows of messages, if any, which specify, for each message, a sender and recipient, a subject or snippet thereof, a body of the message or snippet thereof, and a date and/or time that the message was received. However, messages section 1020 may differ from messages section 620 in that it only includes messages about the particular request sent by the platform and/or messages regarding the particular request for insurance to which the user interface pertains. Accordingly, it is not necessary to provide an identifier of the request for insurance associated with each message as provided in messages section 620.

In an embodiment, loss history section 1030 comprises information related to a pertinent loss history, if any, uploaded or specified by the business-user for the request. As discussed in greater detail elsewhere herein, the loss history may comprise a list of documents and associated information (e.g., date each document was uploaded) related to a loss or losses experienced by the business-user with respect to the particular request for insurance.

In an embodiment, agents section 1040 may be identical to agents section 640. Alternatively, agents section 1040 may be similar to agents section 640, but the list of agent-users may only comprise agent-users relevant to the particular request for insurance to which the user interface pertains. For instance, the agents section 640 may comprise a list of only those agent-users to whom the particular request for insurance was forwarded or from whom a quotation was received.

2.1.8. Quote Analyzer User Interface

FIGS. 11A-11C illustrate example user interfaces for a unique quote analyzer that permits a business-user to compare the details of the quotations received for a request for insurance in a transparent, apples-to-apples fashion. While the user interfaces illustrate the quote analyzer in the context of workers compensation insurance, it should be understood that described embodiments may be adjusted to apply to other types of insurance as well (e.g., general liability, errors and omissions, privacy/data breach, etc.). Furthermore, while the illustrated embodiment shows a user interface for comparing three quotations, it should be understood that any number of quotations may be displayed.

FIG. 11A illustrates a user interface displaying a contracted quote analyzer 1120, according to an embodiment. The user interface comprises details 1110 about the particular request for insurance to which the quotations pertain, including, for example, an identifier or type of the policy being requested, a status of the request (e.g., “quoted”), an effective policy date and/or expiration date of the policy being requested, a unique identifier or reference number for the request, and/or the like.

The quote analyzer 1120, illustrated in FIG. 11A, comprises details for three different quotations in a grid format, wherein each of columns 1150A-1150C represents one entire quotation and each row 1136A-1142 represents a particular aspect (e.g., variable value) of the quotations. Each of columns 1150A-1150C may comprise a header which identifies (e.g., by name) the agent-user who submitted the corresponding quotation and/or the agency associated with the agent-user. Header rows may also be provided across all columns 1150A-1150C to identify a total amount of the quotation and/or insurance carrier for the quotation (e.g., row 1130) and/or identify the displayed values (e.g., row 1134). The business location for which the quotation amounts apply to may also be specified (e.g., in a row 1132). It should be understood that demarcated sections of rows may be provided for each business location included in the request for insurance (e.g., rows 1134-1138 or some subset thereof may be repeated for each business location) and/or navigation may be provided to navigate between different quote analyzers 1120 for each of the business locations. It should also be understood that the columns and rows may be switched from what is illustrated, such that the rows, rather than the columns, correspond to individual quotations.

In the illustrated embodiment, which involves quotations for workers compensation insurance, header row 1134 indicates that the rows 1136A-1136C comprise values for the applicable class code, estimated payroll for the class code, and applicable premium for the class code. Each of rows 1136A-1136C indicates values, including quoted premiums for each displayed quotation, for a single class code. The class codes provided by the business-user during the request generation process are fixed, and thus, each agent-user is required to provide values for those class codes in that agent-user's quotation. However, as discussed elsewhere herein, each agent-user may also add class codes during the quotation generation process. Accordingly, there may be additional row(s) for each class code that was added by an agent-user. Since not all agent-users may have added class codes or the same class codes (e.g., some may not have added any class codes at all, some may have added different class codes, etc.), there may be rows 1136 for class codes for which one or more of the agent-users have not supplied values. In this case, some indication (e.g., “N/A”, “0”, “−”, etc.) may be provided that the agent-user did not supply values for that particular agent-added class code. In addition, the class codes that were included in the business-user's request and the class codes that were added by one or more agent-users may be differentiated from each other (e.g., using color, shading, or other indication or demarcation). Furthermore, any other agent-modified information (i.e., that deviates from the information specified by the business-user in the request), such as a change in the rating basis, may be highlighted (e.g., using colors, shading, or other indication or demarcation).

In an embodiment, a row 1138 may provide a subtotal of premiums for each of columns 1150, a row 1140 may provide applicable taxes and fees, and a row 1142 may provide a total cost of the quoted insurance policy including both the subtotal of premiums and the applicable taxes and fees. In addition, each of the columns 1150 may comprise an expansion input 1160 (e.g., icon, link, button, etc.), which, when selected, expands the associated quotation column to include additional information on each row 1136. For example, this additional information may include a breakdown of the basis for the premium amount in the column, as illustrated in FIG. 11B.

FIG. 11B illustrates a user interface displaying a fully expanded quote analyzer 1120, according to an embodiment. Specifically, each column 1150 has been expanded (e.g., by selecting expansion input 1160). It should be understood that some of the columns 1150 may be in an expanded state, as illustrated in FIG. 11B, at the same time that some of the columns 1150 are in a contracted state, as illustrated in FIG. 11A. Notably, once a column 1150 is expanded, the expansion icon 1160 is replaced with a contraction icon 1160 that, when pressed, will return the associated quotation column to its contracted state.

In the illustrated embodiment, each row for a quotation column 1160 in the expanded state comprises additional information that shows the basis from which the premium amount was calculated. Specifically, this additional information may comprise the rating basis amount (e.g., payroll in the context of workers compensation insurance, sales, payroll, and/or square footage in the context of general liability, etc.), the net rate (e.g., calculated by the agent-user, as discussed elsewhere herein), and the premium amount. In this case, the premium amount is equal to the basis amount multiplied by the net rate (or net rate divided by one hundred when expressed as a percentage, as in the illustrated example). Optionally, the additional information may also comprise a repeat of the class code for easier visual association of the class code with the quotation values as the rows are expanded across the display.

Advantageously, because each agent-user is required to provide the basis for its quotation—e.g., the exact class codes used, and the rating basis amounts and net rates used for each class code—each quotation is transparent to the business-user. For instance, if one or more of the user-agents is using an improper or inappropriate class code, basis amount, and/or net rate (e.g., in order to provide a lower premium amount and win the bid), the business-user will be able to see this in the expanded and/or contracted states.

In addition, because each agent-user is required to provide the same information (e.g., class codes used, and the rating basis amounts and net rates used for each class code, including the class codes specifically specified by the business-user), the business-user is also able to compare the quotations side-by-side in an apples-to-apples manner. Accordingly, the business-user is able to easily, quickly, and visually determine how and why the quotations differ.

FIG. 11C illustrates how the quotations may be filtered, so as to display fewer or more quotations side-by-side, according to an embodiment. Specifically, a business-user may interact with an input or inputs for selecting the agent-users whose quotations should be displayed in quote analyzer 1120. In the illustrated embodiment, the business-user filter the agents by selecting the input 1170, which, when selected, causes a pop-up to be displayed with a list of selectable identifiers (e.g., names) of the agent-users who have provided quotations. Each agent-user identifier in the pop-up is associated with a checkbox input, which can be selected or unselected. In addition, an input may be provided which allows the business-user to select all agent-users who have provided quotations.

The quotations associated with the selected agent-users will be represented in columns 1150 in quote analyzer 1120, and quotations associated with unselected agent-users will not be represented in quote analyzer 1120. Thus, as illustrated, since “Agent 1” and “Agent 3” have been selected in the filter pop-up associated with input 1170, the quotations from Agent 1 and Agent 3 are represented as columns 1150A and 1150B, respectively, in quote analyzer 1120. However, since “Agent 2” has not been selected in the filter pop-up associated with input 1170, the quotation from Agent 2 is not represented in quote analyzer 1120.

In an embodiment, the quotations represented in quote analyzer 1120 may be ranked and/or ordered (e.g., from left to right) according to one or more criteria (e.g., premium amount, incumbent status, etc.). In addition, the quote analyzer may comprise additional and/or different information for each quotation than what is illustrated in the figures. For example, the quote analyzer may also provide additional policy information, such as coverage, exclusions, endorsements and/or other modifications to coverage, policy forms, terms, and/or conditions, and/or the like, and/or additional services provided by the agent or insurance carrier, such as loss control, risk management, safety services, claims management, premium audits, contract analysis and consultation, other legal assistance, property inspection services, and/or the like. Furthermore, the quote analyzer user interface may comprise additional filters for filtering and/or sorting the quotations according to various attributes (e.g., rates, cost, price, rating basis, any of the policy information and/or additional services above, etc.).

2.1.9. Loss History User Interface

FIGS. 12A-12C illustrate example user interfaces for viewing and/or uploading a loss history for a business-user, according to an embodiment. The loss histories may be associated with or attached to particular requests for insurance or particular types of insurance policies.

FIG. 12A illustrates a loss-history user interface before any loss history has been added. The user interface may comprise a filter (e.g., drop-down) for viewing all insurance policy types or selecting a certain type of insurance policy (e.g., workers compensation, general liability, errors and omissions, privacy/data breach, etc.). When a business-user selects a specific policy type, loss histories for only those types of insurance policies will be listed. Otherwise, all loss histories will be listed (e.g., in row format), regardless of policy type.

The loss-history user interface may also comprise an input (e.g., icon, link, button, etc.) for attaching a loss history. When the input is selected, the business-user may be directed to a user interface for attaching a loss history. For example, a pop-up for attaching a loss history may be displayed, as illustrated in FIG. 12B. As illustrated, the user interface for attaching the loss history comprises may comprise inputs for specifying a particular request for insurance (e.g., identified by name) to which the loss history is to be attached, a type of insurance policy to which the loss history is pertinent, a description of the loss history, for uploading an electronic document that is pertinent to the loss history, and/or the like. The user interface may also comprise inputs for cancelling generation of the loss history, in which case the business-user may be returned to the user interface illustrated in FIG. 12A, and for attaching the loss history, in which case the business-user may be directed to the user interface illustrated in FIG. 12C.

FIG. 12C illustrates the loss-history user interface after a loss history has been added. As illustrated, the user interface displays a row for each added loss history. Each row may comprise a request for insurance, policy type, policy dates, description, filename for an uploaded electronic document, an input for editing the loss history, and/or the like.

2.2. Matching Process

In an embodiment, when generating a request for insurance and/or when specifying preference information (e.g., during registration or in an account profile), a business-user may specify the number of agent-users to whom a request for insurance, submitted by the business-user, should be forwarded. Alternatively or additionally, the business-user may specify the number of quotations to be received for the request for insurance. Alternatively, the platform may determine or specify (e.g., as a default or system setting) the number of agent-users to whom the request should be forwarded and/or the number of quotations to be received for the request.

In embodiments that utilize the number-of-agents value for requests, if the number of agent-users to whom a request should be forwarded is N, the platform may select N agent-users from a directory of agent-users, and forward the request for insurance to each agent-user (e.g., by associating and displaying the request in the lead section 310 associated with the agent-user).

In embodiments that utilize the number-of-quotations value for requests, if the number of quotations to be received for the request is N, the platform may select N initial agent-users from the directory of agent-users, and forward the request for insurance to each agent-user (e.g., by associating and displaying the request in the lead section 310 associated with the agent-user). However, if any of the initial agent-users fail or decline to provide a quotation, the platform may select a new agent-user from the directory for each failed or declined request until N quotations are received for the request. Thus, for example, if the business-user specifies or the platform determines that six quotations should be received for a request, the platform will forward the request to six initial agent-users. Then, if three of the initial agent-users fail or decline to provide a quotation to the business-user (e.g., by selecting an input associated with the request, by allowing a certain time period from when the request was received to expire, etc.), the platform may select three additional agent-users, and forward the request to these three additional agent-users. This process may repeat until six quotations have been provided for the request.

It should be understood that certain embodiments may both ensure that a request for insurance is forwarded to a specified or determined number of agent-users and that a specified or determined number of quotations are received. For example, if the number of user-agents to receive the request is X and the number of quotations to be received is Y, the platform may forward the request to X agent-users and decline any agent-users who fail to submit a quotation before Y quotations are received. Alternatively, the platform may forward the request to Y initial agent-users, and select and forward the request to an additional agent-user each time one of the agent-users declines the request up to a maximum of X total agent-users.

The selection of the agent-users to whom to send a request for insurance from a business-user may be based on one or more criteria and/or specification by the business-user. In an embodiment, the business-user may select one or more of the agent-users, and the platform may select any additional agent-users needed to satisfy the specified or determined number of agent-users and/or received quotations, based on one or more criteria. Alternatively or as an additional option, the platform may select all of the agent-users. As another alternative or additional option, the business-user may be permitted to select one agent (e.g., an “incumbent” agent-user from whom any prior policy or the policy being replaced was previously purchased by the business-user), and the platform may select all of the remaining agent-users based on one or more criteria.

In embodiments which utilize selection criteria, the platform may compare attributes of the request for insurance to attributes of one or more agent-users registered with the platform and/or give preference to agent-users with certain attributes, without certain attributes, who meet thresholds for certain attributes, etc. to determine whether one or more selection criteria are met. The selection criteria used by the platform for matching agent-users to a particular request for insurance from a business-user may comprise consideration of one or more of the following:
(1) Type of insurance policy requested (e.g., workers compensation, general liability, errors and omissions, privacy/data breach, property and casualty, employee benefits, etc.);
(2) Industry type for which insurance is requested (e.g., by Standard Industrial Classifications (SIC) or International Organization for Standardization (ISO) codes);
(3) Geographical area for which insurance is requested (e.g., city, state, county, Zip code, etc.).
(4) Demographics of the agent-user, such as years of experience, focus of industry types (specialization), premium size of book (i.e., how much business the user-agent does), average premium per client, average number of employees per client, average annual sales per client, specialty services offered by the agent-user, etc.;
(5) Demographics of the agency with which the agent-user is associated, such as premium size of agency, number of direct carrier appointments, number of Managing General Agent (MGA), wholesale, and/or surplus appointments, number of agents, primary representation (e.g., local, regional, national, etc.), number of agency locations, etc.;
(6) Reviews of the agent-user and/or agency, e.g., business-users can provide reviews of agent-users or agencies, for example, in the form of a full-blown review (e.g., on several performance issues, such as responsiveness, professionalism, knowledge, price, coverage offered, etc.) or a simple thumbs-up or thumbs-down (e.g., via icons), wherein a thumbs-up indicates that the business-user would like to receive a quote from the agent-user or agency in the future, and a thumbs-down indicates that the business-user would not like to receive a quote from the agent-user or agency in the future;
(7) Performance of the agent-user or agency (e.g., as calculated by the platform), such as the length of time it takes the agent-user to respond to requests for insurance, quote-to-lead ration, win ratio of leads (e.g., number of requests awarded over the number of requests received, and including, e.g., win ratio in general, win ratio within specific industries, geographical areas, and/or for specific policy types, etc.), amount of time that the agent-user has been in the system (e.g., time since the agent-user registered with the platform), average number of messages sent to business-users per request, number of times that the user-agent has entered complete quotation details (e.g., for the quote analyzer) as opposed to just a summary, etc.;
(8) Criteria specified by the agent-user and/or agency that indicates which kinds of requests for insurance that the agent-user/agency wishes to receive; and
(9) Criteria specified by the business-user that indicates which kinds of agent-users and/or agencies from which the business-user wishes to receive quotations.

As discussed above, in some embodiments, the business-user may invite agents to provide a quotation for a particular request for insurance. The agent may be an agent-user that has registered with the platform (e.g., an incumbent agent whom the business-user has previously used within the platform). Alternatively or additionally, the business-user may invite an agent, who has not registered with the platform, to join the platform and/or to provide a quotation for a particular request for insurance. If the agent is already registered with the platform, the platform forwards a request to the agent-user through the platform. However, if the agent is not already registered with the platform, the platform may send an invitation to the agent (e.g., by sending an email message to an email address of the agent provided by the business-user). The invitation may comprise a link for registering with the platform and/or for submitting a quotation using a guest account with the platform (e.g., which does not require registration or requires only partial registration).

2.3. Market Selection Process

In an embodiment, the platform allows a business-user to define the market selection for a request for insurance. Typically, commercial insurance companies only allow one insurance agent to obtain a quotation from the insurance company for a particular business. For instance, the insurance company or “Market” generally assigns its representation to the first insurance agent that meets its submission requirements. This creates an environment in which incumbent insurance agents (i.e., an insurance broker selected to represent the insurance company) have a tremendous advantage. For instance, the incumbent insurance agent typically has the information necessary to approach an insurance company ninety days before a policy inception date, whereas other potential and competing agents do not yet have the necessary information for approaching the insurance company. Thus, in essence, the incumbent agent can “corner the Market(s)” by getting assignments from multiple insurance companies before competing agents have the information necessary to obtain representation of the insurance company.

Savvy businesses could require each agent to provide its list of insurance companies that the agent wishes to represent. The business could then determine which agents are to represent which insurance companies. This process may be termed “Market selection.” In an embodiment, the platform facilitates Market selection.

In an embodiment, the platform assigns Markets on behalf of business-users. Firstly, the platform may prompt agent-users to submit (e.g., via one or more inputs of a user interface) a list of insurance carriers that they wish to represent (e.g., during the process of generating a quotation for a request for insurance, during registration, when specifying preference information, etc.). The list may be limited to a certain number of insurance carriers, and/or agent-users may be provided with the ability to rank the list of insurance carriers from most preferred to least preferred. Secondly, the platform may assign the insurance carriers to agent-users, who have been forwarded a particular request for insurance, based on one or more selection methods. The selection method(s) used may be selected or determined by the platform and/or specified by the business-user (e.g., when generating or submitting the request for insurance or as a user preference). The selection method(s) may comprise one or more of the following:
(1) Snake Draft: in a series of one or more rounds, according to a draft order, the platform sequentially assigns the highest-preferred insurance carrier remaining for each agent-user to the agent-user. The draft order of the first round may be random, and, after each round, the draft order may be changed (e.g., reversed such that the agent with the last selection in the completed round is given the first selection in the next round). In this manner, the available Markets are divided up, such that each agent-user, to whom the request is to be forwarded, will be exclusively assigned to represent one or more insurance carriers;
(2) Incumbent-Preferred Draft: firstly, the incumbent agent-user is assigned N number (e.g., one, two, three, etc.) of its most-preferred insurance carriers, and, secondly, a Snake Draft is used to assign the remaining insurance carriers to the remaining agent-users to whom the request is to be forwarded; and
(3) Auction: each agent-user bids on the insurance carrier(s) that they wish to represent, and the platform assigns each insurance carrier to the agent-user with the highest bid for that insurance carrier.

FIG. 13 illustrates the process of market selection described above, according to an embodiment. The process 1300 begins with step 1310. In step 1310, a ranked list of insurance carriers are received from each participating agent-user. As discussed above, this ranked list may be received from the agent-users at different times. For example, the ranked list may be received from each agent-user as that agent-user submits its quotation for a particular request for insurance, during agent registration, when specifying preference information, etc.

In step 1320, the process branches, depending on which “draft” method is used: an incumbent-preferred snake draft or a regular snake draft. Step 1320 may be omitted if only one draft method is available. For example, if only the incumbent-preferred draft method is implemented by the platform, steps 1320 and 1340 may be omitted from process 1300, and the platform may progress instead from step 1310 to step 1320. Alternatively, if only the regular snake draft is implemented by the platform, steps 1320, 1330, and 1332 may be omitted from process 1300, and the platform may progress instead from step 1310 to step 1340.

If the incumbent-preferred method of market selection is used, process 1300 proceeds to step 1330, in which N of the most highly-ranked insurance carriers from the incumbent agent-user's ranked list are assigned to the incumbent agent-user. From step 1330, process 1300 proceeds to step 1332, in which a draft sequence for the remaining (i.e., non-incumbent) agent-users, participating in a particular request for insurance, is determined.

On the other hand, if the regular snake draft is used for market selection, process 1300 proceeds to step 1340, in which a draft sequence for all of the agent-users, participating in a particular request for insurance, is determined.

Once a draft sequence has been determined, either for all of the participating agent-users in step 1340 or for the non-incumbent agent-users in step 1332, process 1300 may proceed through one or more draft rounds. Specifically, in step 1350, it is determined whether any agent-users have yet to “draft” an insurance carrier in a current draft round. If so, in step 1352, that agent-user is assigned the most highly ranked “undrafted” (i.e., unassigned) insurance carrier on the agent-user's ranked list, and process 1300 proceeds again to step 1350. Otherwise, if the current draft round is complete, process 1300 proceeds to step 1354, in which it is determined whether any “undrafted” insurance carriers remain. If not, process 1300 ends. Otherwise, in step 1356, a new draft sequence is determined (e.g., by reversing the completed draft sequence), and process 1300 returns to step 1350.

In an alternative or additional embodiment, the platform allows business-user to assign Markets to the agent-users. As with the prior embodiment discussed above, the platform may prompt agent-users to provide a ranked list of insurance carriers that they wish to represent. The platform may then provide the business-user with a user interface—e.g., when generating or submitting a request for insurance—for assigning one or more insurance carriers on the list for each agent-user, to whom the request is to be forwarded, to the agent-user.

2.4. Feedback Process

The platform may provide user interfaces and/or inputs for providing feedback (e.g., a review) about a particular agent-user and/or agency. For example, in an embodiment, one or more of the following methods may be used by a business-user to submit feedback:
(1) Quick Review: the business-user may select a “thumbs up” or “thumbs down” input associated with an agent-user and/or agency. Selection of the “thumbs up” input indicates that the business-user would like to receive a quotation from the agent-user/agency in the future. Selection of the “thumbs down” input indicates that the business-user would not like to receive a quotation from the agent-user/agency in the future; and
(2) Thorough Review: the business-user may complete a thorough review of an agent-user or agency. This review may comprise responses to several performance-related prompts (e.g., questions) about an agent-user/agency provided in a user interface. The performance-related issues addressed by the review may comprise, without limitation, responsiveness, professionalism, knowledge of products and services, price, coverage offered, services offered, communication, presentation, and the like. The responses to the prompts may comprise numerical rankings (e.g., on a scale from one to five or one to ten) and/or text comments.

Feedback received by business-users for an agent-user and/or agency may be used by the platform to provide ratings of agent-users and/or agencies. In addition, the feedback may be used by the platform as selection criteria when selecting agent-users to whom a request for insurance should be forwarded. For example, if a business-user has previously indicated that it would not like to receive a quotation from a particular agent-user and/or agency (e.g., using the “thumbs down” input or in a thorough review), then that agent-user may be automatically excluded from the selection process or receive a lower weighting in the selection process whenever that particular business-user submits a request for insurance. On the other hand, if the business-user has previously indicated that it would like to receive a quotation from a particular agent-user and/or agency (e.g., using the “thumbs up” input or in a thorough review), then that agent-user may be automatically selected or receive a higher weighting during the selection process whenever that particular business-user submits a request for insurance. In addition, agent-users or agencies which have received low ratings (e.g., because business-users have submitted primarily negative feedback about the agent-user/agency) may receive lower weightings in the selection process for all or a subset of submitted requests for insurance, and agent-users or agencies which have received high ratings (e.g., because business-users have submitted primarily positive feedback about the agent-user/agency) may receive higher weightings in the selection process for all or a subset of submitted requests for insurance.

In an embodiment, the platform may also calculate or otherwise determine ratings for agent-users and/or agencies based on performance metrics within the platform. These performance metrics may be calculated or otherwise determined generally and/or for specific industries, types of insurance policy, geographic areas, etc. For example, the platform may track performance metrics for each agent-user and/or agency, including, without limitation:
(1) Responsiveness: this may comprise the average length of time that it takes the agent-user and/or an agency (e.g., all agent-users associated with the agency) to respond to requests for insurance, messages from business-users, etc.;
(2) Quote-to-Lead Ratio: the ratio of quotations provided to leads (i.e., requests for insurance) received;
(3) Win Ratio: the ratio of accepted quotations to the number of quotations submitted either generally or with respect to specific industry(ies), type(s) of insurance policy, and/or geographic area(s), the ratio of accepted quotations to the number of leads (i.e., requests for insurance) received either in generally or with respect to specific industry(ies), type(s) of insurance policy, and/or geographic area(s), etc.
(4) Time in System: the length of time that the agent-user/agency has participated in the platform (e.g., since the agent-user registered), which may be indicative of an experience level with the platform;
(5) Number of Agent-to-Business Messages Per Request for Insurance: the average number of messages sent by the agent-user/agency to business-users for a request for insurance;
(6) Complete Quotations: the number of times that the agent-user/agency has submitted a complete quotation (e.g., comprising complete details for the quote analyzer) as opposed to just a summary quotation (e.g., comprising only some details, such as price), the ratio of the number of complete quotations submitted to the number of all quotations submitted, the ratio of the number of incomplete (i.e., summary) quotations submitted to the number of all quotations submitted, the ratio of the number of complete quotations submitted to the number of incomplete quotations submitted, etc.; and/or
(7) Services offered via the quote analyzer and/or user profile.

2.5. Agent Bid Process

In an embodiment, the platform allows agent-users to bid for lead(s) and/or Market(s) (i.e., representations of certain insurance carriers), and assigns lead(s) and/or Market(s) to agent-users based on the bids. For example, agent-users may be allowed to financially compete for leads and/or Markets in an auction process with the agent-user having the top bid winning the leads and/or Market(s).

One or more of the following methods may be used for the bidding process:
(1) Agent-users are provided business demographics for a business-user or group of business-users, and then the agent-users place bids to participate in the quotation process for the business-user(s) based on those demographics;
(2) Agent-users are provided the name(s) and complete demographics of a business-user or group of business-users, and then the agent-users place bids to participate in the quotation process for the business-user(s) based on the name(s) and complete demographics;
(3) Agent-users are provided one or more criteria, and then the agent-users place bids to participate in the quotation processes for business-users matching the one or more criteria or to receive higher weighting in the selection process for requests received from business-users matching the one or more criteria; and
(4) Agent-users place bids to represent specific Markets (i.e., insurance carriers). For example, if two or more agent-users both bid to represent Travelers Insurance™, the agent-user with the highest bid would be assigned to represent Travelers Insurance™ for the purposes of obtaining quotations. This bidding may occur for individual requests for insurance (e.g., after a request has been forwarded to selected agent-users), and may be combined with the Market selection process described elsewhere herein. For example, in embodiments in which the platform performs the Market selection, the platform may assign each Market to the agent-user that bid the highest for that Market. Alternatively or additionally, agent-users may pay or bid to receive preference and/or a higher weighting in the Market selection process (e.g., treatment as an incumbent in the described incumbent-preferred method of Market selection, first pick in the first draft sequence, etc.).

2.6. Quotation Flagging Process

In an embodiment, the platform scans or parses each quotation submitted by an agent-user and extracts information that should be highlighted or otherwise brought to the attention of a business-user. For example, the platform may extract any exclusions, endorsements, coverages, etc. that may provide insights into the quotation and/or points of comparison with other quotations. This extracted information may then be provided in the quote analyzer (e.g., in the quote analyzer user interface discussed with respect to FIGS. 11A-11C) or presented or highlighted to the business-user in some other user interface.

The platform may flag extracted information to the business-user (e.g., in the quote analyzer) based on its potential risk to the business of the business-user based on industry, policy type, and/or keywords. The platform may maintain one or more search criteria and/or allow a business-user to specify search criteria (e.g., via one or more inputs of a user interface during generation or submission of a request for insurance, when setting preferences, etc.) to be used when determining whether information should be extracted from a quotation. The platform then searches quotations for the search criteria, and flags or highlights (e.g., in the columns 1150 of the quote analyzer) any information in each quotation that matches the search criteria. The search criteria may include, without limitation, keywords, policy form identifiers (e.g., form numbers for policy forms which include terms, conditions, exclusions, and/or endorsements), and/or other bodies or documents used to build an insurance policy.

2.7. Lead Forwarding Process

As discussed elsewhere herein, agent-users may specify (e.g., via one or more inputs of a user interface during registration, when setting preferences, etc.) one or more leads criteria (e.g., the leads preferences specified via the user interface illustrated in FIG. 2C). The platform may then use the leads criteria when selecting agent-users to whom a request for insurance will be forwarded.

In an embodiment, the platform may tentatively forward a request for insurance to a selected agent-user when it matches the agent-user's leads criteria and/or based on any other selection means. The agent-user may then be given a certain, set amount of time (e.g., twenty-four hours, one week, etc.) to accept the lead. If the agent-user does not accept the lead within the set amount of time, the platform may then select another agent-user and tentatively forward the request for insurance to that agent-user. On the other hand, if the agent-user accepts the leads within the set amount of time—e.g., using an input of a user interface, such as an input in a row corresponding to the lead in leads section 310 of the agent dashboard user interface illustrated in FIG. 3—the agent-user is then provided with the ability to submit a quotation for the request for insurance.

In an embodiment, the agent-user may select an auto-accept option (e.g., via an input in a user interface for setting preferences for the agent-user), which automatically accepts any request for insurance forwarded to the agent-user. In this manner, the agent-user can avoid missing any leads.

It should be understood that this lead forwarding process may be used in conjunction with the business-specified number of agent-users for a request for insurance, discussed elsewhere herein. Specifically, in embodiments in which a business-user specifies the number of agent-users to whom a request for insurance should be forwarded, the platform may forward the request to sets of one or more agent-users until the specified number of agent-users have accepted the request.

2.8. Leads Board Process

In an embodiment, the platform provides a leads board. The leads board comprises a list of leads (i.e., requests for insurance) from which an agent-user can select leads. In such embodiments, the agent-users select leads, instead of relying on the platform to select agent-users for leads.

In an embodiment, the leads board is general or “open.” In such an embodiment, the leads board may be provided on a user interface that is available to all or a subset of a plurality of agent-users. These agent-users may view the user interface and select or acquire those leads for which it desires to provide a quotation.

In an alternative or additional embodiment, the leads board is private. In such an embodiment the leads board may be provided on the agent dashboard user interface (e.g., as illustrated in FIG. 3) as part of leads section 310 or as a separate section. Alternatively, the leads board may be provided on a separate user interface available as part of the agent-user's account. In either case, the platform may push leads to each agent-user's private leads board based on matching criteria specified by the agent-user (e.g., as leads preferences specified via the user interface illustrated in FIG. 2C) and/or determined by the platform. As with the leads forwarding process, the agent-user may have an auto-accept option to automatically accept any leads that are pushed to it by the platform.

The leads board may be similar in format to the leads section 310 illustrated in FIG. 3. For example, the leads board may comprise a row for each lead, and each row may comprise an identifier of the business-user that submitted the request, the type of insurance policy being sought, the date and/or time that the request was received, the effective date of the policy being sought, one or more inputs for viewing the request and/or accepting the lead, and/or the like. Alternatively or additionally, each row may comprise an industry type for the request, a company size of the business-user that submitted the request, a type of insurance policy being sought, an agent selection criteria, and/or the like.

It should be understood that this leads board process may be used in conjunction with the business-specified number of agent-users for a request for insurance, discussed elsewhere herein. Specifically, in embodiments in which a business-user specifies the number of agent-users to whom a request for insurance should be forwarded, the platform may remove a request from the leads board or otherwise make the request unavailable for acceptance after the specified number of agent-users have accepted the request.

2.9. Insurance Carrier Selection Process

In an embodiment, business-users may have an option to specify one or more criteria for an insurance carrier that is to provide the requested insurance policy. For example, the business-user may be provided with one or more inputs, during the request generation or submission process or as a setting on a user interface for setting user preferences, for entering one or more such criteria. For example, the one or more criteria may include, without limitation, a carrier rating (e.g., AAA, A− and above, etc.). The business-user may also choose not to define any criteria, e.g., if the business-user is simply interested in receiving the cheapest insurance policy available.

When the business-user has specified one or more criteria for insurance carriers, the agent-users who accept the request for insurance from the business-user, may be limited by the platform to provide quotations for only those insurance carriers that meet the specified criteria. For example, if the business-user has specified that all insurance carriers should have a rating of AAA, the agent-users may be limited to providing quotations for insurance carriers with a rating of AAA.

It should be understood that this insurance carrier selection process may be used in conjunction with the Market selection process, described elsewhere herein. For example, during the Market “draft,” if a Market or insurance carrier in a ranked list of insurance carriers for an agent-user does not meet the insurance carrier criteria specified by the business-user, that insurance carrier may be “undraftable” and therefore passed over during the “draft” process. In other words, the agent-user would be assigned the next highest ranked insurance carrier on its list that does meet the insurance carrier criteria specified by the business-user.

2.10. Dynamic Request Builder Process

As discussed with respect to FIGS. 7A-7C, the process for building a request for insurance may be dynamic. In an embodiment, a business-user specifies initial information, including an insurance policy type and industry for the request, in an initial set of one or more user interfaces (e.g., as illustrated in FIGS. 7A-7C). Once the platform receives this initial information, it may dynamically generate an additional set of one or more user interfaces (e.g., as illustrated in FIGS. 8A-8F for the context of workers compensation insurance) based on the initial information. For example, this additional set of user interface(s) may comprise one or more user interfaces with questions or other prompts that are specific to the specified type of insurance policy (e.g., as illustrated in FIG. 8B for the context of workers compensation) and/or the specified industry (e.g., as illustrated in FIG. 8D for the context of non-construction contractors). The policy-specific and industry-specific prompts may be retrieved by the platform from one or more relational databases (e.g., database(s) 112) using an identifier of the policy type or industry, respectively, as an index into the database(s). The policy-specific and industry-specific user interface(s) may then be dynamically constructed by inserting the retrieved prompts into template(s) or server pages (e.g., Active Server Page (ASP), JavaServer Page (JSP), etc.) for corresponding to the user interface(s).

Furthermore, in an embodiment, the platform may automatically or, upon request, provide recommendations (e.g., via a user interface) to the business-user for certain inputs during the process of generating a request for insurance. For example, the platform may recommend and/or prepopulate the class codes for the policy-specific information (e.g., in the user interface illustrated in FIG. 8B) based on information previously obtained from the business-user, such as the specified policy type, the specified industry, and/or other information about the business-user or its business.

2.11. Copy Process

In an embodiment, the platform allows a business-user to copy information collected for a prior request for insurance into a new request for insurance. Advantageously, this may streamline and ease the burden of the request generation process. This may be an option that the business-user must actively select each time a new request is started, an option that the business-user may actively select as a preference or default for all future requests, and/or an automatic feature of the platform. In either case, if this copy feature is used, the platform may prepopulate the inputs in the user interfaces for a new request for insurance with available and appropriate information collected in a prior request for insurance.

This feature may be limited to copying information from one policy type to a request for the same policy type. Alternatively, the feature may not be limited in this manner, thereby also copying appropriate information from one policy type to a request for a different policy type. In this case, it should be understood that not all information may be copied. For example, if the information is being copied from one policy type to a request for a different policy type, to the extent that the inputs require different information, some or all of the policy-specific information (e.g., obtained through the user interface illustrated in FIG. 8B) may not be copied, such as the estimated rating basis, etc. However, to the extent that at least some of the inputs require some of the same information obtained for the different policy type, these inputs may be prepopulated with at least some of the previously-obtained policy-specific information.

2.12. Policy and Certificate Management

In an embodiment, the platform stores the insurance policies and insurance certificates for a business-user (e.g., in database(s) 112, as Portable Document Format (PDF) documents or other electronic documents, etc.). These policies and certificates may be stored in the cloud and accessible by the business-user from anywhere in the world through the Internet.

In addition, the platform may provide management features for business-users' insurance policies and certificates through its various user interfaces and software modules. These features may include, without limitation, requesting insurance certificates from the appropriate agent-user and/or insurance carrier, requesting to add, edit, and/or delete vehicles from automobile insurance policies, requesting to add, edit, and/or delete building and/or locations from property insurance policies, requesting to add, edit, and/or delete employees from benefit plan insurance policies, and/or the like.

2.13. Automated Broker of Record Process

For a variety of reasons, a business may wish to change the incumbent or prospective agent (i.e., the “Broker of Record”) that is representing the business. Typically, there is a standard form that must be completed by the business and submitted to the new insurance company on the business' letterhead. In an embodiment, the platform facilitates this Broker of Record process by generating the form on a business-user's letterhead. For example, the business-user may upload and store its letterhead on the platform (e.g., in database(s) 112). Then, when requested by the business-user (e.g., via an input of a user interface), the platform may generate the form information (e.g., name of the insurance carrier, policy type, inception date, new agent name, etc.) on the business' letterhead using information stored for the business-user.

The generated letter may then be downloaded as an electronic document (e.g., PDF document, Microsoft Word™ document, etc.) or printed by the business-user. Alternatively or additionally, the platform may transmit the letter as an electronic document (e.g., PDF document) to the new agent (e.g., using email) or using an interface with the agent (e.g., transmitting the request in XML or some other format to an Internet-based interface of the agent). Alternatively, if the agent is registered with the platform as an agent-user, the letter may be sent as an electronic document via an internal message system of the platform, such that the document appears in, or is attached to a message that appears in, the agent-user's messages section 320. In an identical or similar manner, a notification may be sent to the agent being replaced as broker of record. It should be understood that, in other embodiments, the communication of the letter to the new agent and/or notification to the replaced agent may be performed non-electronically, such as through regular mail.

2.14. Automated Loss Run Process

Loss runs are documents that are required by insurance carriers before they will quote a particular policy for a prospect. A loss run summarizes loss information sustained by prior carriers during a given period, or, if there is no loss information, states that there were no losses. The information necessary for loss runs is the name of the business, the type of insurance policy, the dates of the policy (e.g., start and end dates), the valuation date (i.e., the date the loss run was published, which is important because most insurance carriers required the valuation date to be within ninety days of the quotation date, e.g., if the business wants a quotation for Jan. 1, 2014, it would need a 3-5 year history of loss runs with a valuation date after Oct. 1, 2013), and a summary of loss information (e.g., total amount incurred, total amount paid, total amount outstanding, names of parties involved, date of incident, narrative, etc.) with values broken down on a per claim basis and annually.

Insurance carriers may require loss runs to be updated annually for all policy types in order to obtain new quotes. Conventionally, it is extremely difficult for a business to obtain old loss runs, since normally they will have to call their present agent and possibly past agent(s) to request copies. In doing so, the called agent(s) may be alarmed by the business' desire to obtain quotes elsewhere, and undermine the process.

Accordingly, in an embodiment, the platform may automate the loss run process so that the business-users do not have to ask present or past agent(s) for its loss runs. For example, the business-user may upload and store its letterhead on the platform (e.g., in database(s) 112). Then, when the business-user authorizes the platform (e.g., via an input of a user interface) to obtain its loss runs, the platform may generate a formal request on the business' letterhead using information (e.g., name of insurance carrier, policy type, policy dates, policy number, etc.) stored for the business-user (e.g., from past policy information) or specified by the business-user (e.g., via input(s) of a user interface).

The generated request may then be downloaded as an electronic document (e.g., PDF document, Microsoft Word™ document, etc.) or printed by the business-user. Alternatively or additionally, the platform may transmit the letter as an electronic document (e.g., PDF document) directly to the relevant insurance carrier(s) or using an interface with the relevant insurance carrier(s) (e.g., transmitting the request in XML or some other format to an Internet-based interface of the insurance carrier). It should be understood that, in other embodiments, the communication of the request to the insurance carrier(s) may be performed non-electronically, such as through regular mail. Also, it should be understood that, in embodiments, the business' letterhead may not be necessary, and therefore, may be omitted.

Once an insurance carrier receives the loss-runs request from the business-user or platform, it may process the request and return the requested loss run information to the business-user or the platform (e.g., via regular mail, electronic mail or other message, Internet-based interface, etc.). In scenarios in which the loss run information is returned to the business-user, the business-user may upload and/or input the information (e.g., using the user interfaces illustrated in FIGS. 12A-12C). In scenarios in which the loss run information is returned to the platform, the information may be automatically entered into the business-user's loss history (e.g., such that it appears in the business-user's loss-history, as illustrated in FIGS. 12A-12C). In either case, the received loss history may be attached to a particular request for insurance.

2.15. Loss Analysis and Underwriting Process

In an embodiment, the platform may provide tools (e.g., comprising user interfaces and/or embedded in user interfaces) to agent-users for analyzing losses (e.g., from a loss history attached to a request for insurance), developing loss picks, identifying subrogation or apportionment potentials, etc. The platform may also provide any other tools that may assist an underwriter in its pricing efforts.

2.16. Insurance Calendar and Reminders Process

In an embodiment, the platform keeps track of expiration dates for all insurance policies managed by a business-user on the platform, and provides a calendar (e.g., calendar section 630 in FIG. 6) that notifies the business-user of important dates regarding the policies. For example, the calendar may comprise an entry for every policy within a certain number of days from expiration, with an indication of when the policy will expire (e.g., the number of days until expiration). In addition, when a policy is within a certain number of days from expiration, the platform may prompt the business-user (e.g., via a pop-up or other user interface with an input) to obtain quotations for a new policy to succeed the expiring policy. If the business-user responds to the prompt in the affirmative, the business-user may be directed to user interfaces for generating a request for insurance (e.g., as illustrated in FIGS. 8A-8H). In an embodiment, the user interfaces may be prepopulated with information from the expiring policy.

In an embodiment, the platform may also provide a calendar that notifies agent-users of important dates regarding requests for insurance and/or policies which they originated. For instance, the calendar may be similar to calendar section 630 in FIG. 6, but appear as a section in the agent dashboard user interface illustrated in FIG. 3. The calendar may comprise entries indicating dates on which or days until an acceptance of a request is due, a quotation for a request is due, an insurance policy originated by the agent-user is expiring (e.g., so that the agent-user may notify the business-user to obtain a new policy), and/or the like.

2.17. Lead Limit

In an embodiment, agent-users may be limited to a certain number of leads for a period of time. For example, each agent-user may have a daily, weekly, monthly, quarterly, or annual limit on the number of leads that can be received or accepted. Once the agent-user has reached that limit, the platform may exclude the agent-user from consideration when selecting agent-users for requests for insurance (in embodiments in which the platform performs at least part of the selection), may no longer forward requests for insurance to the agent-user (e.g., in embodiments in which the platform provides private leads boards), and/or may no longer allow the agent-user to accept requests for insurance (in embodiments in which the platform provides a public leads board), depending on the particular method(s) used to assign leads to agent-users. In addition, the platform may notify the agent-user that the limit has been reached.

In some embodiments, the agent-user may be permitted to purchase the ability to accept additional leads, and the platform may notify the agent-user of this when notifying the agent-user that the current limit has been reached. For example, agent-users may purchase a certain limit of leads, with higher limits costing more than lower limits, and, optionally, representing volume discounts. These limits may be tiered (e.g., N₁ leads for $X₁, N₂ leads for $X₂, etc.) or may be specified by the agent-user (e.g., any numerical value with price determined based on marginal rates). If the agent-user reaches the limit, then the agent-user may be prompted to pay to increase the agent-user's limit.

3. Example Processing Device

FIG. 14 is a block diagram illustrating an example wired or wireless system 550 that may be used in connection with various embodiments described herein. For example the system 550 may be used as or in conjunction with one or more of the mechanisms, processes, methods, or functions (e.g., to store and/or execute the application or one or more software modules of the application) described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and/or the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and/or the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and/or the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block-oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software, such as the disclosed application) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and/or the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and/or the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A system for presenting multiple insurance quotations for a request for insurance, the system comprising:
at least one hardware processor; and
one or more software modules that, when executed by the at least one hardware processor,
receives a request for insurance from a business-user, the request for insurance comprising one or more class codes;
communicates the request for insurance to a plurality of agent-users;
receives a plurality of quotations for the request for insurance from the plurality of agent users, wherein each of the plurality of quotations comprise, for each of the one or more class codes, a rating basis and a net rate; and
provides a user interface to the business-user, wherein the user interface comprises information for two or more of the plurality of quotations in a grid comprising cells arranged in both a vertical direction and a horizontal direction,
wherein each of the two or more quotations is represented in a first one of the vertical direction and the horizontal direction,
wherein each of the one or more class codes is represented in a second one of the vertical direction and the horizontal direction, and
wherein, for each of the two or more quotations, for each of the one or more class codes, one or more cells, corresponding to the quotation in the first direction and the class code in the second direction, comprise the rating basis, the net rate, and an insurance premium amount for the class code.

2. The system of claim 1, wherein, for each of the two or more quotations, at least one cell, corresponding to the quotation in the first direction, comprises one or more of a tax amount and fee amount for the quotation.

3. The system of claim 2, wherein, for each of the two or more quotations, at least one cell, corresponding to the quotation in the first direction, comprises a total insurance premium amount for the quotation.

4. The system of claim 1, wherein the user interface further comprises one or more filter inputs configured to receive a selection of one or more of the plurality of quotations, and wherein the grid comprises information for all of the plurality of quotations selected through the one or more filter inputs.

5. The system of claim 1, wherein one or more of the plurality of quotations further comprise one or more additional class codes, which were not comprised in the request for insurance, and wherein, for each of the two or more quotations, for each of the one or more additional class codes, one or more cells, corresponding to the quotation in the first direction and the additional class code in the second direction, comprise, if provided in the quotation, the rating basis, the net rate, and an insurance premium amount for the additional class code.

6. The system of claim 1, wherein the one or more software modules further:
parse each of the plurality of quotations to identify any exclusions and endorsements; and,
if any exclusions or endorsements are identified, notify the business-user of any identified exclusions and endorsements.

7. The system of claim 1, wherein the one or more software modules further, prior to communicating the request for insurance to the plurality of agent-users, determine the plurality of agent-users to whom the request for insurance is to be communicated by:
receiving an indication of at least one of the plurality of agent-users from the business-user; and
selecting at least one of the plurality of agent-users based on one or more criteria.

8. The system of claim 1, wherein the one or more software modules further assign representation of one or more insurance carriers to each of the plurality of agent-users.

9. The system of claim 8, wherein assigning representation of one or more insurance carriers to each of the plurality of agent-users comprises:
receiving a ranked list comprising a plurality of insurance carriers from each of the plurality of agent-users;
assigning representation of one or more insurance carriers from the ranked list received from an incumbent one of the plurality of agent-users to the incumbent agent-user prior to any assignment of representations of insurance carriers to any remaining ones of the plurality of agent-users; and
assigning representation of different one or more insurance carriers to the remaining agent-users based on the ranked lists received from the remaining agent-users.

10. The system of claim 8, wherein assigning representation of one or more insurance carriers to each of the plurality of agent-users comprises:
receiving a ranked list comprising a plurality of insurance carriers from each of the plurality of agent-users;
determining an order of the plurality of agent-users; and,
in a plurality of draft rounds,
in the determined order for each of the plurality of agent-users, assigning representation of a highest-ranked, unassigned insurance carrier from the ranked list received from the agent-user to the agent-user, and,
if a next draft round exists in the plurality of draft rounds, changing the order of the plurality of agent-users for the next draft round.

11. The system of claim 1, wherein the one or more software modules further receive an acceptance of one of the plurality of quotations from the business-user.

12. The system of claim 11, wherein the one or more software modules further:
track one or more performance metrics for an agent-user, wherein the one or more performance metrics comprise one or more of a ratio of a number of quotations received from the agent-user to a number of requests for insurance communicated to the agent-user and a ratio of a number of quotations received from the agent-user and accepted to a number of requests for insurance communication to the agent-user; and
generating a review of the agent-user based on the one or more performance metrics.

13. A non-transitory computer-readable medium having one or more sequences of instructions stored therein, wherein the one or more sequences of instructions, when executed by a processor, cause the processor to:
receive a request for insurance from a business-user, the request for insurance comprising one or more class codes;
communicate the request for insurance to a plurality of agent-users;
receive a plurality of quotations for the request for insurance from the plurality of agent users, wherein each of the plurality of quotations comprise, for each of the one or more class codes, a rating basis and a net rate; and
provide a user interface to the business-user, wherein the user interface comprises information for two or more of the plurality of quotations in a grid comprising cells arranged in both a vertical direction and a horizontal direction,
wherein each of the two or more quotations is represented in a first one of the vertical direction and the horizontal direction,
wherein each of the one or more class codes is represented in a second one of the vertical direction and the horizontal direction, and
wherein, for each of the two or more quotations, for each of the one or more class codes, one or more cells, corresponding to the quotation in the first direction and the class code in the second direction, comprise the rating basis, the net rate, and an insurance premium amount for the class code.

14. The non-transitory computer-readable medium of claim 13, wherein one or more of the plurality of quotations further comprise one or more additional class codes, which were not comprised in the request for insurance, and wherein, for each of the two or more quotations, for each of the one or more additional class codes, one or more cells, corresponding to the quotation in the first direction and the additional class code in the second direction, comprise, if provided in the quotation, the rating basis, the net rate, and an insurance premium amount for the additional class code.

15. The non-transitory computer-readable medium of claim 13, wherein the one or more sequences of instructions further cause the processor to, prior to communicating the request for insurance to the plurality of agent-users, determine the plurality of agent-users to whom the request for insurance is to be communicated by:
receiving an indication of at least one of the plurality of agent-users from the business-user; and
selecting at least one of the plurality of agent-users based on one or more criteria.

16. The non-transitory computer-readable medium of claim 13, wherein the one or more sequences of instructions further cause the processor to assign representation of one or more insurance carriers to each of the plurality of agent-users by:
receiving a ranked list comprising a plurality of insurance carriers from each of the plurality of agent-users;
determining an order of the plurality of agent-users; and,
in a plurality of draft rounds,
in the determined order for each of the plurality of agent-users, assigning representation of a highest-ranked, unassigned insurance carrier from the ranked list received from the agent-user to the agent-user, and,
if a next draft round exists in the plurality of draft rounds, changing the order of the plurality of agent-users for the next draft round.

17. A method for presenting multiple insurance quotations for a request for insurance, the method comprising using at least one hardware processor to:
receive a request for insurance from a business-user, the request for insurance comprising one or more class codes;
communicate the request for insurance to a plurality of agent-users;
receive a plurality of quotations for the request for insurance from the plurality of agent users, wherein each of the plurality of quotations comprise, for each of the one or more class codes, a rating basis and a net rate; and
provide a user interface to the business-user, wherein the user interface comprises information for two or more of the plurality of quotations in a grid comprising cells arranged in both a vertical direction and a horizontal direction,
wherein each of the two or more quotations is represented in a first one of the vertical direction and the horizontal direction,
wherein each of the one or more class codes is represented in a second one of the vertical direction and the horizontal direction, and
wherein, for each of the two or more quotations, for each of the one or more class codes, one or more cells, corresponding to the quotation in the first direction and the class code in the second direction, comprise the rating basis, the net rate, and an insurance premium amount for the class code.

18. The method of claim 17, wherein one or more of the plurality of quotations further comprise one or more additional class codes, which were not comprised in the request for insurance, and wherein, for each of the two or more quotations, for each of the one or more additional class codes, one or more cells, corresponding to the quotation in the first direction and the additional class code in the second direction, comprise, if provided in the quotation, the rating basis, the net rate, and an insurance premium amount for the additional class code.

19. The method of claim 17, further comprising, prior to communicating the request for insurance to the plurality of agent-users, determining the plurality of agent-users to whom the request for insurance is to be communicated by:
receiving an indication of at least one of the plurality of agent-users from the business-user; and
selecting at least one of the plurality of agent-users based on one or more criteria.

20. The method of claim 17, further comprising assigning representation of one or more insurance carriers to each of the plurality of agent-users by:
receiving a ranked list comprising a plurality of insurance carriers from each of the plurality of agent-users;
determining an order of the plurality of agent-users; and,
in a plurality of draft rounds,
in the determined order for each of the plurality of agent-users, assigning representation of a highest-ranked, unassigned insurance carrier from the ranked list received from the agent-user to the agent-user, and,
if a next draft round exists in the plurality of draft rounds, changing the order of the plurality of agent-users for the next draft round.
